(19) United States
(12) Patent Application Publication
(10) Pub. No.: US 2014/0046788 A1
(43) Pub. Date: Feb. 13, 2014

(54) PAYMENT METHOD AND SYSTEM

(71) Applicant: KT CORPORATION, Gyeonggi-do (KR)

(72) Inventors: Sang-Yup LEE, Seoul (KR); Soo-Chul PARK, Gyeonggi-do (KR)

(73) Assignee: KT CORPORATION, Gyeonggi-do (KR)

(21) Appl. No.: 13/961,221

(22) Filed: Aug. 7, 2013

(30) Foreign Application Priority Data
Aug. 7, 2012 (KR) 10-2012-0086435

(51) Int. Cl. G06Q 20/36

(52) U.S. Cl. CPC G06Q 20/363
USPC 705/21

(57) ABSTRACT

A payment method and a system are provided. The payment method allows making a payment for a purchased product with an electronic wallet account linked with a telephone number.

### CROSS-REFERENCE TO RELATED APPLICATIONS

This application claims the benefit of Korean Patent Application No. 10-2012-0086435, filed with the Korean Intellectual Property Office on Aug. 7, 2012, the disclosure of which is incorporated herein by reference in its entirety.

### BACKGROUND

1. Technical Field

The present disclosure relates to a method and a system for real-time payment through an electronic wallet of a user without using a credit card or cash.

2. Background Art

In typical methods of payment, when a user is both on or off-line, the user is normally required to make a cash payment, deposit funds in a separate account, or make a payment with a credit card on hand. However, in order to make a payment with a credit card through a user terminal, typical methods require that credit card information is pre-stored in the user terminal.

These typical methods have shortcomings of requiring the user to physically possess cash or the credit card or have the credit card information pre-stored in the user terminal. When the credit card information is pre-stored in the user terminal, high risks exist of having the credit card information stolen through various malicious methods. Accordingly, there is a need for techniques for the user to make a payment by use of the user terminal without using cash or a credit card, or the user having the credit card information stored in the user terminal

### SUMMARY

The present disclosure relates to making a real-time payment through an electronic wallet of a user, without the use of a credit card or cash.

The present disclosure also relates to a method and a system for allowing a real-time payment to be made from the electronic wallet by having an electronic tag recognized, even if no payment terminal is available.

In accordance with at least one embodiment, a method may be provided for making a payment using an electronic wallet. The payment method may include receiving a payment request including user information, point of sale (POS) information and payment amount from a user terminal, wherein the user terminal obtains the POS information by reading a tag displayed through a POS terminal or attached to the POS; processing a payment by deducting the payment amount from the balance of a first electronic wallet account linked to the user information according to the payment request and adding the payment amount to the balance of a second electronic wallet account linked to the POS information; and notifying the payment processing result to at least one of the user terminal and the POS terminal corresponding to the POS information.

At least one of the user information and the POS information may be a telephone number.

After processing a payment, the payment method may further include synchronizing at least one balance of a prepaid card and a virtual account linked to the first electronic wallet account according to the balance change of the first electronic wallet account.

The synchronizing the balance may include transmitting a synchronizing request including the balance information changed according to the payment processing to the user terminal and a server authorizing use of the prepaid card, if the first electronic wallet account is linked with a prepaid card; and transmitting to a financial institution system, a synchronizing request including the balance information changed according to the payment processing, if the first electronic wallet account is linked with a virtual account.

After processing a payment, the payment method may further comprise synchronizing with the balance of the virtual account by transmitting a synchronizing request including the balance information changed according to the payment processing to a financial institution system when the second electronic wallet account is linked with a virtual account.

The processing a payment may deduct the payment amount from the balance allowed for the use from the total balance of the first electronic wallet account.

After processing a payment, the payment method may further comprise reflecting the change by deducting the balance changed according to the payment processing from the total balance of a patent account in the group when the first electronic wallet account is configured as a group.

Prior to the processing a payment, according to the payment request, when the balance of the first electronic wallet account is less than the payment amount, the payment method may comprise transmitting a payment pending message due to insufficient balance to at least one of the user terminal and a representative terminal corresponding to the parent account of the group including the first electronic wallet account; receiving a payment verifying request from the parent account to the first electronic wallet account for the insufficient payment amount among the payment amount from the representative terminal; and processing by deducting the insufficient payment amount from the balance of the parent account and adding that to the balance of the first electronic wallet account.

Prior to the processing a payment, according to the payment request, when the balance of the first electronic wallet account is less than the payment amount, the payment method may comprise transmitting a payment pending message for the insufficient payment amount to at least one of the user terminal and a representative terminal corresponding to the parent account of the group including the first electronic wallet account; and receiving a payment verifying request from the parent account to the first electronic wallet account for the insufficient payment amount among the payment amount from the representative terminal. In the processing a payment, a part of the payment amount may be deducted from the balance of the first electronic wallet account, the remainder of the payment amount may be deducted from the balance of the parent account, and the payment amount is added to the balance of the second electronic wallet account.

The payment method may further comprise receiving a synchronizing request including balance information according to a prepaid card payment; and synchronizing the balance of the first electronic wallet account with the balance information according to the synchronizing request.

When the prepaid card is a transportation card which is issued to a smart card attached to the user terminal, the user terminal may transmit a synchronizing request including the balance information, when the balance is changed with payments of the transportation card, through a background-executing program.

The first electronic wallet account can be linked with a plurality of other accounts prioritized in accordance with their uses.

Deducting the payment amount from the balance of the first electronic wallet account is processed by deducting the payment amount from the balance of the other accounts in the prioritized order.

In accordance with another embodiment, a server and a system may be provided for providing a payment service based on the electronic wallet. The payment support server may include a communication unit, a service control unit, and a message generating unit. The communication unit may be configured to receive a payment request including user information, POS information and payment amount from a user terminal, wherein the user terminal obtains the POS information by reading a tag attached to a POS and displayed through a POS terminal. The service control unit may be configured to process a payment by deducting the payment amount from the balance of the first electronic wallet account in accordance with the payment request and adding the payment amount to the balance of the second electronic wallet account linked to the POS information. The message generating unit may be configured to generate a payment result message corresponding to the payment processing, wherein the payment result message is transmitted to at least one of the user terminal and the POS terminal corresponding to the POS information.

The payment support server may further include a synchronizing unit. The synchronizing unit may be configured to synchronize at least one balance of a prepaid card and a virtual account linked to the first electronic wallet account according to the balance change of the first electronic wallet account.

When the first electronic wallet account is linked with a prepaid card, the synchronizing unit may transmit a synchronizing request including the balance information changed according to the payment processing to the user terminal and a server authorizing use of the prepaid card. When the first electronic wallet account is linked with a virtual account, that the synchronizing unit transmits the synchronizing request to a financial institution system.

When the second electronic wallet account is linked with a virtual account, the synchronizing unit may transmit a synchronizing request including the balance information changed according to the payment processing to a financial institution system and synchronize it with the balance of the virtual account.

When the first electronic wallet account is configured as a group, the synchronizing unit may reflect the balance changed according to the payment processing to the balance of a parent account of the group.

The balance of each electronic wallet account may be specified and managed according to each use types and the parent account may be configured to manage a total balance for the use type by combining the balance of the electronic wallet account of each member of the group according to the corresponding use type.

The service control unit may deduct the payment amount from the balance authorized for the use type of the total balance of the first electronic wallet account and the synchronizing unit may synchronize by deducting the balance deducted for the payment processing according to the use type.

The payment support server may further include an account verification unit. The account verification unit may be configured to determine if the balance of the first electronic wallet account is less than the payment amount or not according to the payment request.

When the balance of the first electronic wallet account is less than the payment amount, the service control unit is configured to control to transmit a payment pending message caused due to insufficient balance to at least one of the user terminal and the representative terminal corresponding to the parent account of the group including the first electronic wallet account.

When a payment verifying request is received to process a payment for the insufficient payment amount through the parent account from the representative terminal, the service control unit may be configured to conduct the payment request by deducting the insufficient payment amount from the balance of the parent account and adding it to the balance of the first electronic wallet account.

The payment support server may further include an account verification unit. The account verification unit may be configured to determine if the balance of the first electronic wallet account is less than the payment amount or not according to the payment request.

When it is less than the payment amount, the service control unit may control transmitting a payment pending message caused due to insufficient balance to at least one of the user terminal and the representative terminal corresponding to the parent account of the group including the first electronic wallet account. When a payment verifying request is received to process a payment for the insufficient payment amount through the parent account from the representative terminal, the payment processing may be conducted by deducting a part of the payment amount as much as the balance of the first electronic wallet account and deducting the rest of the payment amount from the balance of the parent account.

When a synchronizing request including balance information according to a prepaid card payment is received, the synchronizing unit may synchronize the balance information with the balance of the first electronic wallet account.

When the prepaid card is a transportation card issued to a smart card attached to the user terminal, the user terminal may transmit a synchronizing request including the balance information, when the balance is changed with payments of the transportation card, through a program executing in background.

In accordance with still another embodiment, a system may be provided for making a payment. The system may include a user terminal and a payment support server. The user terminal may be configured to obtain POS information by reading a tag attached to a POS or displayed through a POS terminal and to generate a payment request including the obtained POS information and a payment amount. The payment support server is configured to process a payment by deducting the payment amount from the balance of the first electronic wallet account linked with the user terminal and corresponding to the payment request of the user terminal and to add the payment amount to the balance of the second electronic wallet account linked with the POS information.

The payment support server may generate a payment result message based on a result of processing the payment and transmit the payment result message to at least one of the user terminal and the POS terminal.

The tag may be at least one of a near field communication (NFC) tag, a radio-frequency identification (RFID) tag, a barcode, and a quick response (QR) code.

The payment support server manages at least one of a prepaid card and a virtual account linked to the electronic wallet account. When the balance of the electronic wallet account changes, the payment support server transmits a synchronizing request message to at least one of the terminal and a predetermined server for synchronizing the balance of the prepaid card and the virtual account.

The prepaid card may be a transportation card issued to a smart card or stored in a server.

When the prepaid card is the transportation card, the user terminal performs an associated program in background. The user terminal transmits a synchronizing request to the payment support server when the balance of the transportation card is changed according to payments made through the prepaid card. Upon the receipt of the synchronizing request, the payment support server synchronizes the balance of the first electronic wallet account with the balance of the transportation card.

In accordance with at least one embodiment, a user is allowed for making a real-time payment through an electronic wallet, without the use of a credit card or cash. Accordingly, the user might become free from the need to carry a number of credit cards or cash the risk of losing or getting the cash and/or credit cards stolen may be minimized.

Furthermore, a real-time payment may be made from the electronic wallet by having an electronic tag recognized, even if no payment terminal is available.

Moreover, at least one of a prepaid card may be synchronized with a virtual account with the electronic wallet.

In addition, it allows synchronizing the balance of each member of a group by configuring electronic wallet accounts as a group.

### BRIEF DESCRIPTION OF THE DRAWINGS

FIG. 1 illustrates making a real-time payment using an electronic wallet account linked with a telephone number in accordance with an embodiment of the present invention.

FIG. 2 is a schematic view of a configuration of a system for payment between terminals based on an electronic wallet account in accordance with an embodiment of the present invention.

FIG. 3 shows an internal configuration of a payment support server in accordance with an embodiment of the present invention.

FIG. 4 is a flow chart illustrating a process for becoming a new member and registering an electronic wallet account to be provided with a payment service linked with a telephone number in accordance with an embodiment of the present invention.

FIG. 5 illustrates a screen displaying the registration result of becoming a new member through a user terminal in accordance with an embodiment of the present invention.

FIG. 6 illustrates a screen displaying a user interface to deposit (charge) a certain amount to an electronic wallet account in accordance with an embodiment of the present invention.

FIG. 7 is a flow chart illustrating a method for (re)charging a certain amount to an electronic wallet account through the deposit to a virtual account in accordance with an embodiment of the present invention.

FIG. 8 is a flow chart illustrating a method for depositing ((re)charging) a certain amount to an electronic wallet account corresponding to a user terminal through a small payment in accordance with an embodiment of the present invention.

FIG. 9 is a user interface screen displayed through a terminal for depositing ((re)charging) a certain amount to an electronic wallet account according to a small payment in accordance with another embodiment of the present invention.

FIG. 10 and FIG. 11 are user interface screens displayed through a user terminal for depositing ((re)charging) a certain amount to an electronic wallet account according to a credit card payment in accordance with another embodiment of the present invention.

FIG. 12 is a flow chart illustrating a method for charging to the balance of an electronic wallet account through real account transfer in accordance with another embodiment of the present invention.

FIG. 13 illustrates a user interface screen displayed through a user terminal for charging to the balance of an electronic wallet account through real account transfer in accordance with another embodiment of the present invention.

FIG. 14 is a flow chart illustrating a method for synchronizing the balance of a virtual account or a prepaid card according to the balance changes of an electronic wallet account at a payment support server in accordance with an embodiment of the present invention.

FIG. 15 is a flow chart illustrating a payment method using an electronic wallet account in accordance with an embodiment of the present invention.

FIG. 16 is a flow chart illustrating a payment method at an electronic wallet account included in a group in accordance with an embodiment of the present invention.

FIG. 17 is a screen illustrating a method for making a payment according to the priorities set for other accounts when an electronic wallet account is linked with a plurality of other accounts in accordance with an embodiment of the present invention.

FIG. 18 is a screen illustrating a method for charging a prepaid transportation card through an electronic wallet account in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of the present invention, when describing a certain relevant conventional technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of the present invention will be described in detail with reference to the accompanying drawings.

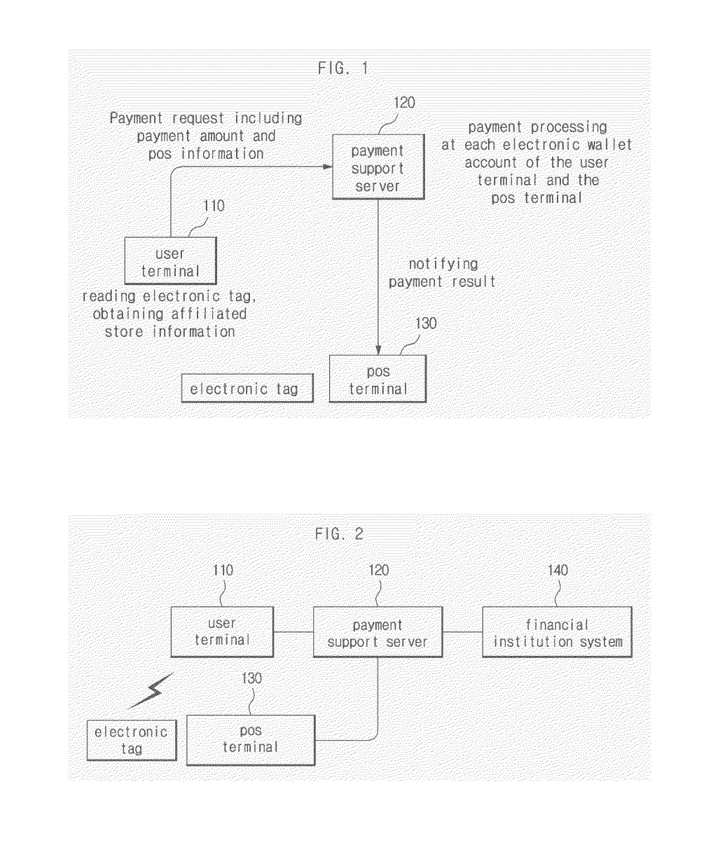

FIG. 1 illustrates real-time payment between terminals using an electronic wallet account linked with a telephone number in accordance with an embodiment of the present invention.

In accordance with at least one embodiment, each user terminal has information on an electronic wallet account linked with corresponding user information and registered through a payment service system. For the convenience of the description and ease of understanding, the following assumes that an electronic wallet account is linked with a telephone number of a user terminal Any identifying means can be equivalently applied as long as a user can be identified (or specified) or the terminal pre-registered by the user can be identified or specified.

Although the electronic wallet account was described as being linked with a telephone number, the present invention is not limited thereto. In addition to the telephone number, various types of user information may be used to identify or specify a user or a terminal linked with the electric wallet account. For example, a name or a nickname of a user may be used to identify a user or a corresponding user terminal liked with the electronic wallet account.

Such an electronic wallet account may be registered by being mapped to at least one of a virtual account, a real account, a pre-paid card, a debit card, and a mobile phone payment account issued by a financial institution.

The user can use a user terminal 1101) to read a tag attached to, output from, and/or displayed by a point-of-sale (POS) terminal and to obtain POS information therefrom, ii) to input the amount of payment and a payment password and then include the POS information, and iii) to transmit a payment request to a payment support server 120.

The tag may be an electronic tag, such as a radio frequency identification (RFID) tag, a near field communication (NFC) tag, or an N-dimensional code. The N-dimensional code may include a quick response (QR) code and a barcode.

Such tag may be attached at a particular location, such as a store. For example, the tag may be attached around an entrance of a store or a payment terminal in the store (e.g., a POS terminal). Furthermore, the tag may be displayed on a display connected with the payment terminal.

The payment support server 120 can check an electronic wallet account corresponding to the obtained POS information (referred to as “POS account” hereinafter) in response to the payment request of the user terminal. The payment support server 120 may deduct a payment amount from the balance of an electronic wallet account associated with the user terminal 110 (hence referred to as “user account” hereinafter) and process the payment by calculating (i.e., adding) the payment amount to the balance of the POS account.

In the case where the electronic wallet accounts corresponding, respectively, to the user terminal and the POS terminal are each linked with a virtual account of a financial institution system, the payment support server 120 may send account synchronization requests pursuant to the processing of the payment in order to synchronize the balance of the electronic wallet accounts with the balance of the virtual account. Here, each of the account requests can include at least one of the balance (or changed amount) and breakdown.

Once a synchronization result is received from the financial institution system pursuant to the account synchronization request, the payment support server 120 may generate a payment result and send the payment result to the user terminal 110.

The payment support server 120 might also or alternatively send the payment result to a POS terminal based on the POS information or to a plurality of terminals registered corresponding to the POS information.

The electronic wallet accounts in accordance with at least one embodiment are accounts in which electronic money is deposited. A method of depositing electronic money in the electronic wallet account is described subsequently in detail.

Although as described herein the virtual account issued by the financial institution system is linked with the electronic wallet account, the electronic wallet account might be or might not be linked with the virtual account.

Hereinafter, for the convenience of the description and ease of understanding, a configuration of a system for payment through an electronic wallet account will be described.

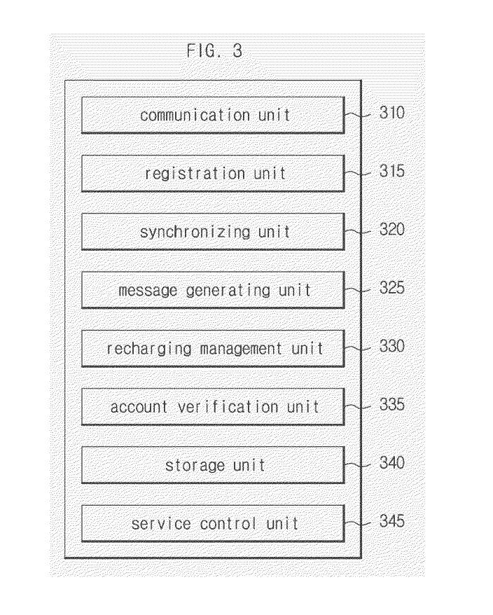

FIG. 2 illustrates a system for making a payment based on an electronic wallet account in accordance with an embodiment of the present invention.

Referring to FIG. 2, the system may include a user terminal 110, a POS terminal 130, a payment support server 120, and a financial institution system 140.

Each of the user terminal 110 and the POS terminal 130 has an electronic wallet account. The electric wallet accounts may be linked with the user terminal 110 and the POS terminal 130 based on terminal information thereof (e.g., telephone number) and registered through the payment support server 120. With use of the electronic wallet account, a mobile payment service may be provided to the user terminal 110 and the POS terminal 130.

The user terminal 110 may be any device portable and capable of reading a tag. For example, the user terminal 110 may include a mobile communication terminal, a personal digital assistance (PDA), a tablet personal computer (PC), a pad-like device, and a notebook computer.

The POS terminal 130 may be a portable electronic device. For example, the POS terminal 130 may include the user terminal 110 or a POS device.

Although not described in detail herein, the user terminal 110 and the POS terminal 130 might have a specially-dedicated program installed therein for operation with a payment service based on the electronic wallet account provide by the payment support server 120. Depending on the way of implementation, the user terminal 110 and the POS terminal 130 might also be provided with a payment service based on the electronic wallet account through a web service without a specially-dedicated program installed therein.

The payment support server 120 can provide the payment service for making a payment amount through the electronic wallet account linked with at least one of the terminal information and the user information of each terminal.

The payment support server 120 may be implemented as a single device or a plurality of servers. In this specification the payment support server 120 is shown and configured as a single device, for the convenience of the description and understanding of the embodiments, but this is exemplary and the present invention is not limited thereto.

The payment support server 120 can register/manage the electronic wallet account based on the terminal information and the user information (or the POS information) of the user terminal 110 and the POS terminal 130. Moreover, in the case where a virtual account issued by the financial institution system 140 is linked with the electronic wallet account, the payment support server 120 may further manage virtual account information in correspondence with the electronic wallet account.

As such, when the electronic wallet account and the virtual account information are linked with each other, and if there is any change of balance in one of the electronic wallet account and the virtual account, the payment support server 120 may be linked with the financial institution system 140 and notify the change to the other of the two accounts to have the balances of the electronic wallet account and the virtual account synchronized with each other.

While the method of making a deposit in the electronic wallet account will be described below in more detail, the payment support server 120 configures and manages the use of the deposited balance differently according to the deposit types in the electronic wallet account. Here, the use can be a payment-related detailed use, such as a shopping category, a POS category, etc., or a use classification, such as payment service or financial service. Moreover, the use can be designated as a non-refundable use for membership, points, and so forth.

Moreover, the payment support server 120 can configure and mange a plurality of electronic wallet accounts as a group. When the electronic wallet accounts are configured as a group, at least one of the plurality of electronic wallet accounts in the group can be configured as a main account. In such a case, a representative of the main account can configure an electronic wallet account of a member within the group as the use and transfer the deposit to the electronic wallet account of the member. Here, the representative can be an owner of the main account. Moreover, for the convenience of the description and understanding of the embodiments, the terminal of the representative is referred to herein as a representative terminal.

Moreover, when a request for transfer of a certain amount is received from the terminal of a member in the group, the representative terminal can specify the use and deposit (transfer) the requested amount to the electronic wallet account of the very member from the balance of the main account.

Moreover, the payment support server 120 can synchronize the balance of the electronic wallet account of the user with the balance of a transportation card that is stored (installed) in the user terminal 110.

Moreover, the payment support server 120 can synchronize the balance of a prepaid card, which may be issued through a credit card company, with the balance of the electronic wallet account of the user. This will be described again in detail later with reference to the relevant drawings.

As described above, the payment support server 120 manages the electronic wallet account corresponding to each user terminal 110 or POS terminal 130 and synchronizes the balances of each electronic wallet account and the prepaid card preregistered by the user. Here, the prepaid card may be a prepaid card that is usable online or that is issued to a smart card of the user terminal 110, for example, a transportation card.

The financial institution system 140 can synchronize the balance of the electronic wallet account registered in the payment support server 120 with the balance of the virtual account, pursuant to a request of the payment support server 120.

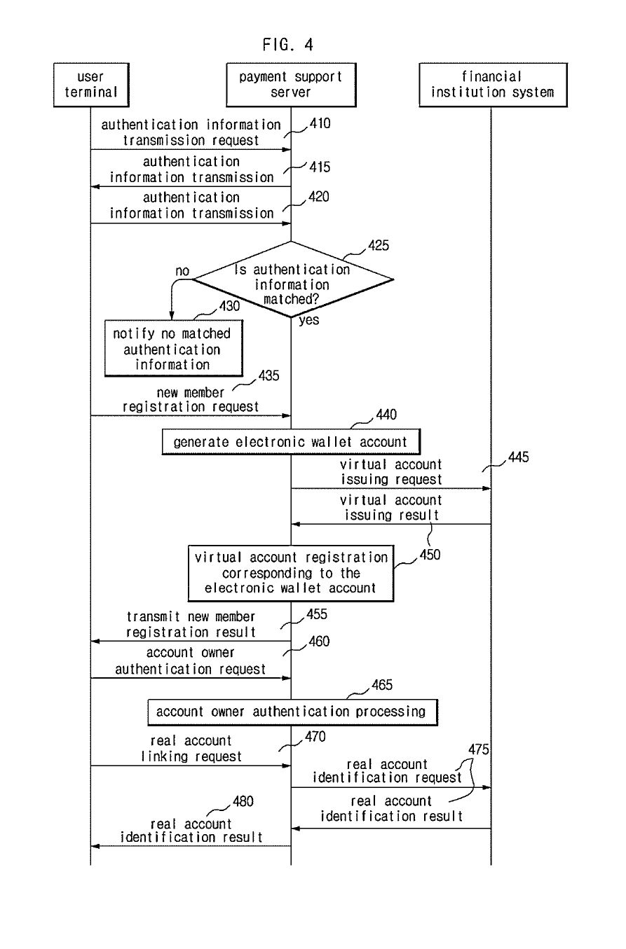

FIG. 3 shows an internal configuration of a payment support server in accordance with an embodiment of the present invention.

Referring to FIG. 3, the payment support server 120 may include a communication unit 310, a registration unit 315, a synchronizing unit 320, a message generating unit 325, a recharging management unit 330, an account verification unit 335, a storage unit 340 and a service control unit 345.

The communication unit 310 can communicate data with other devices (e.g., user terminal 110, financial institution system 140, and so forth) through a communication network.

For example, the communication unit 310 can receive a payment request or a recharging request from the user terminal 110 and output the request to the service control unit 345. Further, the communication unit 310 can send a synchronization request to the financial institution system 140 or the user terminal 110 according to the control.

The registration unit 315 can register the user by use of user information and terminal information, pursuant to receiving a user registration request including the user information and the terminal information from the user terminal 110. The registration unit 315 can generate and register the electronic wallet account by use of at least one of the user information and the terminal information.

Here, the user information may be information, such as user name, address, date of birth, email address, nickname, SNS account information, Internet personal identification number (I-PIN), etc., with which the user can be identified.

Moreover, the terminal information may be information for identifying the pertinent terminal 110, for example, a telephone number, an international mobile subscriber identity (IMSI), and so forth. For the convenience of the description and understanding of the embodiments, in the present specification that the terminal information is assumed to be a telephone number, but the present invention is not limited thereto.

The electronic wallet account can be registered by being linked with the terminal information (e.g., telephone number). For example, in case the telephone number of the user terminal 110 is “010-1111-2222,” the electronic wallet account may be generated and registered as “##-010-1111-2222.” Here, “##” may indicate an index number registered in correspondence with the telephone number of the user terminal.

For example, in the case that John Doe requested an electronic wallet account for “010-1111-2222,” the electronic wallet account may be generated as “00-010-1111-2222.” Then, if John Doe changes his telephone number and John Doe's telephone number is newly issued to Richard Roe, and if Richard Roe requests an electronic wallet account for the newly issued “010-1111-2222,” the electronic wallet account may be generated as “01-010-1111-2222” for Richard Roe.

As described, the electronic wallet account for John Doe or for Richard Roe may not be identified by using only the telephone number. Accordingly, the registration unit 315 may generate/register the electronic wallet account by additionally using the user information (e.g., name) when registering the electronic wallet account.

The synchronizing unit 320 can synchronize the balance of the electronic wallet account associated with a prepaid card stored in the user terminal 110 or a prepaid card stored in another device pre-designated by the user with the balance of the virtual account issued by the financial institution system 140.

Accordingly, in the case that the balance of the electronic wallet account of the user is changed, the synchronizing unit 320 can send a synchronization request, which includes information about the changed balance, to the user terminal 110 or the designated financial institution system 140 for synchronization with the linked prepaid card or virtual account.

Moreover, the synchronizing unit 320 can receive the synchronization request from the user terminal 110 or the financial institution system 140 and synchronize the balance of the electronic wallet account of the user.

In another example, in case that the electronic wallet account of the user is configured as a group and that the balance of the electronic wallet account is changed, the synchronizing unit 320 can reflect the change and synchronize the balance of a parent account configured in the group, in addition to synchronization with the virtual account and/or prepaid card linked with the electronic wallet account of the user.

The message generating unit 325 can generate a notification message, an information message, and the like to be sent to at least one of the user terminal 110 and the POS terminal 130 according to the control of the service control unit 345. For example, the message generating unit 325 can generate messages in any form of short message, lengthy message, multimedia message, a message in a SNS account and the like. The message content can be associated corresponding with user information (e.g., telephone number) at the SNS account. When a user registers for a payment service through an electronic wallet account, the corresponding SNS account information can be separately input. When the SNS account information is separately registered in correspondence with an electronic wallet account, this allows sending a notification message, an information message and the like through the SNS account.

Moreover, the message generating unit 325 can send a notification message, an information message and the like along with certain text and/or image that is predetermined at a POS. This can prevent malicious parties from impersonating as a POS by sending a notification message, an information message and the like along with the certain text and/or image predetermined at each POS. For example, when a payment is made through an electronic wallet account at a first POS, a message to be sent to a user terminal that includes a certain text or image (or words, for example, “ZooMoney No. 1”) predetermined at the POS. Thus, malicious activity is prevented by sending a message along with different words or images, etc. according to variable conditions (such as time, date, location and the like) from the POS.

Although it is assumed for the convenience of the description and understanding of the embodiments that a message is generated and sent to at least one of a user terminal 110 and a POS terminal 130 through the message generating unit 325, any message such as a notification message, an information message and the like in the form of push message, in addition to the described one, can be equivalently generated and sent.

The recharging management unit 330 can request for transmitting a charge notification message to the user terminal 110 when the balance of each electronic wallet of a user account is less than a predetermined amount.

Moreover, the recharging management unit 330 can designate the use according to a deposit method when a certain amount is deposited in the electronic wallet account by a user.

For example, a user can deposit ((re)charge) a certain amount to the electronic wallet account through a virtual account deposit using the financial institution system 140 or through any method of small payment, credit card payment, real account deposit, and so forth.

Here, the recharging management unit 330 can designate the use for a deposited amount according to a deposit method. For example, when a charge for a certain amount is requested through virtual account deposit or real account deposit, the recharging management unit 330 can add the certain amount (which is charged (deposited) to the balance of the electronic wallet account and designate the use as “banking” for the specific charged amount.

In another example, when a charge for a certain amount is requested through small payment or credit card payment to the electronic wallet account, the recharging management unit 330 can add the (re)charged amount to the balance of the electronic wallet account and designate the use as “payment” for the specific (re)charged amount.

Here, the use may be designated for a particular category such as “book”, “food”, “family events”, “performance” and the like for detailed payments, in addition to such uses described above.

For example, when the electronic wallet account of a user is configured as a group and a representative (e.g., parent) within the group transfers a certain amount from a parent account to the electronic wallet account, the representative can transfer the certain amount by specifying the use.

In such a case, the transferred amount to the electronic wallet account may be designated for the particular use and be realized not to make a payment for other uses, except the designated use. For the convenience of the description and ease of understanding, transferring was described as being made from the patent account to the electronic wallet account. The present invention, however, is not limited thereto. A (re)charge may be requested for the use when a certain amount is charged as any method for depositing to another's (e.g., patent's) electronic wallet account.

The account verification unit 335 can verify status and balance of each electronic wallet account of a user.

For example, the account verification unit 335 i) verifies the electronic wallet account corresponding to (linked to) terminal information of the user terminal 110 with a payment request of the user terminal 110, ii) determines if the electronic wallet account is available (for example, if the electronic wallet account is a dormant account or if a balance is enough to make a payment, and so forth.), and iii) notifies the result to the user terminal 110.

Further, according to a payment request of the user terminal 110, the account verification unit 335 verifies the electronic wallet account corresponding to POS information included in the payment request and notifies the obtained information to the user terminal 110.

The storage unit 340 stores various programs and/or algorithms required for operating the payment support server 120 in accordance with at least one embodiment. The storage unit 340 also stores an electronic wallet account linked to the telephone number of each user. The storage unit 340 further stores at least one of prepaid card and virtual account information linked to an electronic wallet account.

The service control unit 345 may control overall operation of the constituent elements including a communication unit 310, a registration unit 315, a synchronizing unit 320, a message generating unit 325, a recharging management unit 330, an account verification unit 335, and storage unit 340 in the payment support server 120 in accordance with at least one embodiment.

Moreover, the service control unit 345 may process a payment by deducting a payment amount from the balance of an electronic wallet account according to the payment request of the user terminal 110 and adding it to the balance of an electronic wallet account corresponding to POS information.

A method for processing a payment through each electronic wallet account of a user will be explained in detail with reference to the accompanying drawings.

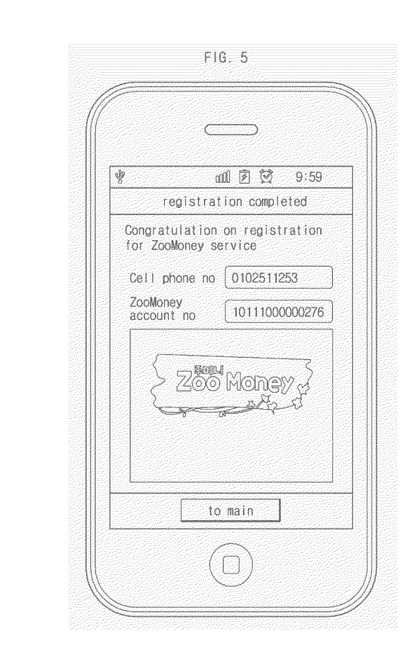

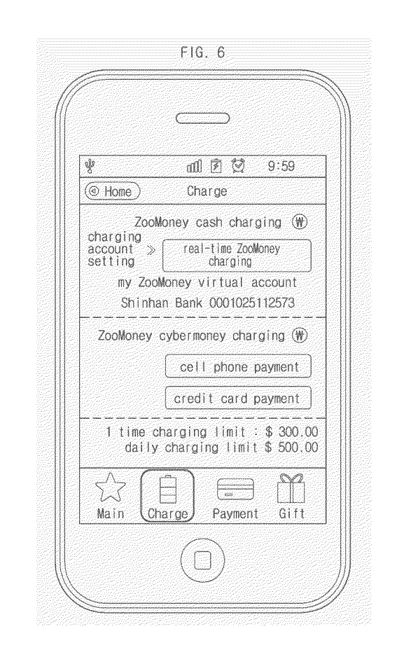

FIG. 4 is a flow chart illustrating a process for becoming a new member and registering an electronic wallet account to be provided with a payment service linked with a telephone number in accordance with an embodiment of the present invention and FIG. 5 illustrates a screen of a user terminal, displaying a registration result of a user in accordance with an embodiment of the present invention.

The payment support server 120 receives an authentication information transmission request for becoming a member of a related service from the user terminal 110 in Step 410.

Accordingly, the payment support server 120 generates and transmits authentication information to the user terminal 110 in Step 415. Here, the payment support server 120 can store the generated authentication information temporarily in correspondence with terminal information of the user terminal 110.

The authentication information can be transmitted in at least one form of a short message, a lengthy message, a multimedia message, and a message in a social networking service (SNS) account to the user terminal 210. Accordingly, the user can verify the authentication information displayed through the user terminal 210 and then input and send the authentication information through the user terminal 210 to a service server 220.

The payment support server 120 receives the authentication information from the user terminal 110 in Step 420.

The payment support server 120 determines if the pre-stored authentication information matches with the received authentication information.

If no match, the payment support server 120 can send an information message of no matching authentication information to the user terminal 110 and stop further processing.

If a match, the payment support server 120 receives a new member registration request including new member registration information from the user terminal 110. Here, the registration information may include at least one of user identification information, group information, user name, terminal information, device identification information, account password, transaction password, email address, nickname, address, and SNS account information.

The user identification information is information to identify a user and can be for example, a social security number, an I-PIN and the like. In addition, one skilled in the art will appreciate that any information which is able to identify a user can be used.

Moreover, the terminal information is information to identify a user terminal For example, the terminal information may be a telephone number of a user terminal The device identification information is information to identify a device such as media access control (MAC) address.

The transaction password is a password for receiving a remittance service to a POS account based on an electronic wallet or for transactions caused by increase or decrease of electronic money corresponding to the user terminal 210.

The account password is a password for accessing to a financial transaction providing system in order to receive financial services (for example, financial transaction services) using an electronic wallet based on a telephone number.

Here, the account password and the transaction password may be at least one of characters, numbers, special symbols and a combination thereof, respectively. The login password and the transaction password may be a pattern or image specified by a user according to an implement method.

The payment support server 120 generates an electronic wallet account linked to terminal information (for example, telephone number) according to a new member registration request in Step 440.

The payment support server 120 then transmits a virtual account issuing request including terminal information and user information to the financial institution system 140 in Step 445.

Here, the virtual account issuing request may further include the generated electronic wallet account information.

Accordingly, the financial institution system 140 issues a virtual account linked to the electronic wallet account and transmits the virtual account issuing result including the issued virtual account information to the payment support server 120.

That is, the payment support server 120 receives the virtual account issue result from the financial institution system 140 and registers virtual account information in correspondence with the electronic wallet account in Step 450. Here, the payment support server 120 can perform member registration based on the member registration information.

FIG. 4 illustrates registering/managing the electronic wallet account linked with the virtual account issued from the financial institution system 140. However, if the electronic wallet account is not linked to the virtual account, Step 445 to Step 450 may not be performed.

After completing the member registration process, the payment support server 120 generates and transmits the member registration result to the user terminal 110 in Step 455.

FIG. 5 illustrates the member registration result notified to the user terminal 210 in correspondence with the member registration completion. As shown in FIG. 5, a financial transaction providing system 200 transmits the member registration result including terminal information of the user terminal in correspondence with the member registration and the issued virtual account to the user terminal 210.

As such, when the member registration process completes, the payment support server 120 generates an electronic wallet account in correspondence with the user terminal 110 and performs an account owner verification process for the user terminal 110.

That is, the payment support server 120 receives an account owner authentication request from the user terminal 110 in Step 460. Here, the account owner authentication request can include at least one of the terminal information and the user identification information.

Accordingly, the payment support server 120 requests to identify an actual account owner of the terminal 210 through a communication company system according to the account owner authentication request, receives the account owner authentication result, and transmits it to the user terminal 110 in Step 465.

When such an account owner verification processing completes, the payment support server 120 receives a real account linking request from the user terminal 110 in Step 470. Here, the real account linking request can include at least one of real account information, virtual account and terminal information.

The real account information can include at least one of real account number and real account password.

The payment support server 120 transmits a real account identification request to a financial institution system 140 according to such a real time linking request in Step 475. Here, the real account identification request can include real account information.

Moreover, the payment support server 120 generates and transmits the real account linking identification result according to the real account identification result from the financial institution system 140 to the user terminal 110 in Step 480.

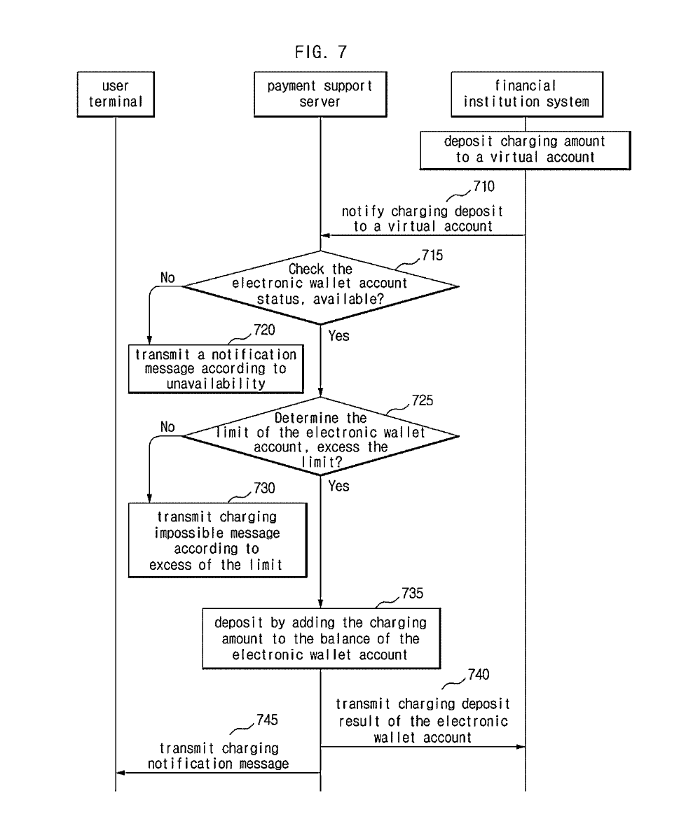

FIG. 6 illustrates a screen displaying a user interface to deposit ((re)charge) a certain amount to an electronic wallet account in accordance with an embodiment of the present invention.

As shown in FIG. 6, a user can deposit a certain amount to the electronic wallet account according to any one of a plurality of (re)charging methods. Here, the (re)charging method can be any one of deposit through the virtual account, deposit through the real account, small payment, and credit card payment.

When the charged amount is deposited in the electronic wallet account according to any one of the (re)charging methods, the payment support server 120 can reflect the balance of the electronic wallet account by the use designated according to the (re)charging method.

Accordingly, each electronic wallet account can manage separately the balance by the use of the (re)charging method. As such, when the user terminal 110 requests for processing a payment or financial service through the electronic wallet account based on telephone number, the payment support server 120 can provide payment or financial service within the balance as the use.

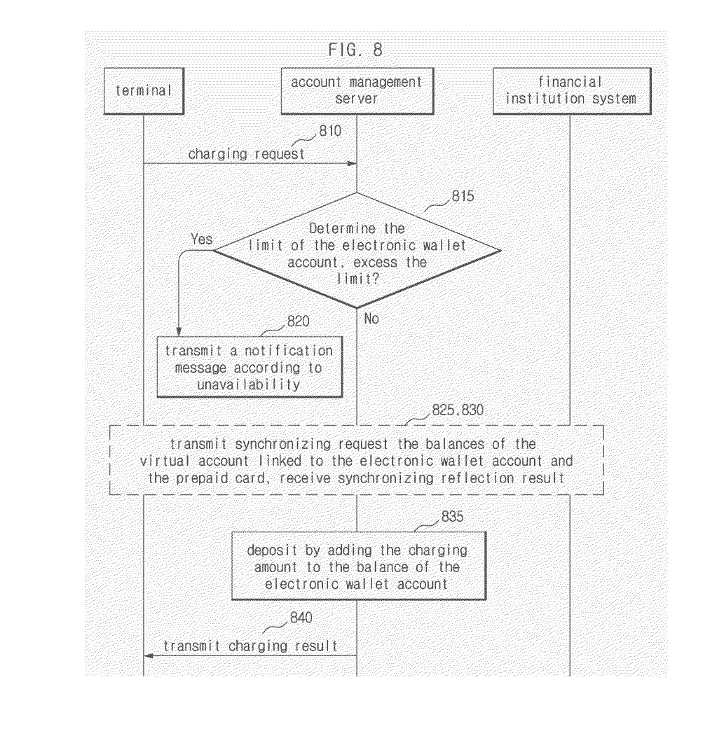

FIG. 7 is a flow chart illustrating a method for (re)charging a certain amount to an electronic wallet account through the deposit to a virtual account in accordance with an embodiment of the present invention.

For the convenience of the description and ease of understanding, the following assumes that a user deposits a certain amount to a virtual account through a financial institution system. Here, the user deposits cash through an automated teller machine (ATM) installed at the financial institution system or transfer a certain amount to the virtual account.

The financial institution system 140 transmits a virtual account deposit notification including the deposited amount and virtual account information in correspondence with deposit to the virtual account of the user to the payment support server 120 in Step 710.

The payment support server 120 verifies the status of the electronic wallet account corresponding to the virtual account according to the virtual account deposit notification from the financial institution system 140 in Step 715.

If it is not possible to use the electronic wallet account (e.g., insufficient funds in account), the payment support server 120 transmits an information message for unavailable electronic wallet account to the user terminal 110 in Step 720.

Here, if the electronic wallet account is in a dormant condition due to long-term unused, the payment support server 120 can notify the status to the user terminal 110, perform activation of the dormant account and, if necessary, recharge it.

If the electronic wallet account is available and usable (e.g., sufficient funds in account), the payment support server 120 identifies the limit amount of the electronic wallet account in Step 725. Here, the limit amount is the maximum amount to be deposited to the electronic wallet account.

If charging amount (which is virtual account deposit amount) exceeds the limit of the electronic wallet account, the payment support server 120 generates and transmits an information message, denying charging due to exceeding of the charging limit amount, to the user terminal 110 in Step 730.

On the other hand, if charging amount is within the limit, the payment support server 120 adds and deposits the charged amount to the balance of the electronic wallet account in Step 735.

Here, the payment support server 120 can deposit to the balance of the electronic wallet account by designating the use according to a deposit method (e.g., (re)charging method). For example, it is assumed that the balance of the electronic wallet account according to the first use is $5.00 and that according to the second use is $30.00. Here, it is assumed that the charged amount is $20.00 and the use according to the (re)charging method is the first use. The payment support server 120 can deposit $25.00 as the balance according to the first use of the electronic wallet account and $30.00 can be deposited for the balance according to the second use without changes. As such, the payment support server 120 can manage not only the total balance of the electronic wallet accounts but also the balance for each use separately. Thus, when a specified payment or financial service is provided through the electronic wallet account according to the request of a user, the payment support server 120 can provide the service within the balance of the use allowed for that use according to each service.

Although it is assumed for the convenience of the description and understanding of the embodiments that the use type of the electronic wallet account is set as any one of “banking” and “payment”, a variety of use types can be set. For example, the use of the balance of the electronic wallet account can be also designated by category according to each payment.

The payment support server 120 generates virtual account deposit result corresponding to the charging amount deposit to the balance of the electronic wallet account and transmits it to the financial institution system 140 in Step 740.

The payment support server 120 generates a charge notification message to the electronic wallet account and requests transmission the charge notification message to the user terminal 110 in Step 745. Here, the charge notification message can include at least one of new deposited amount (which is charged amount), balance by the use, and total balance.

Here, the charge notification message can be sent in a text message form such as short message, lengthy message, and multimedia message to the user terminal 110 or requested to send in a push message form to the user terminal 110.

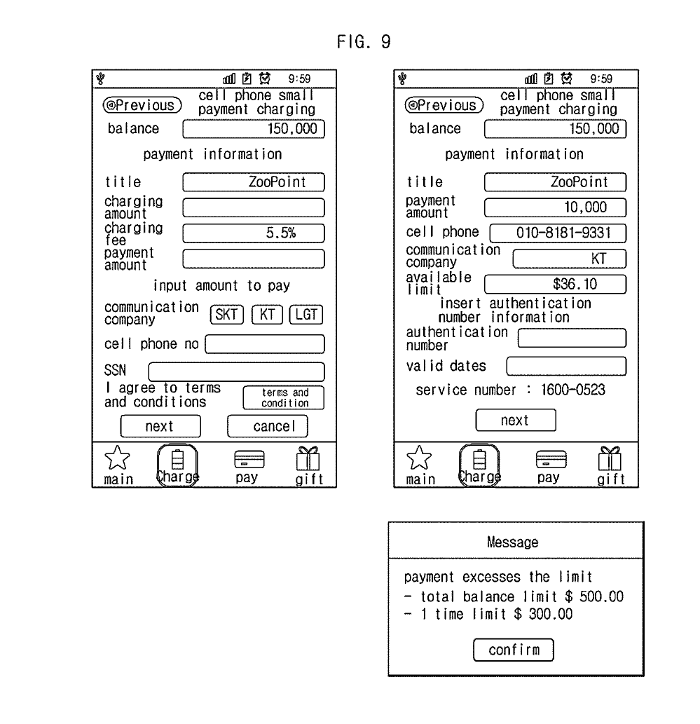

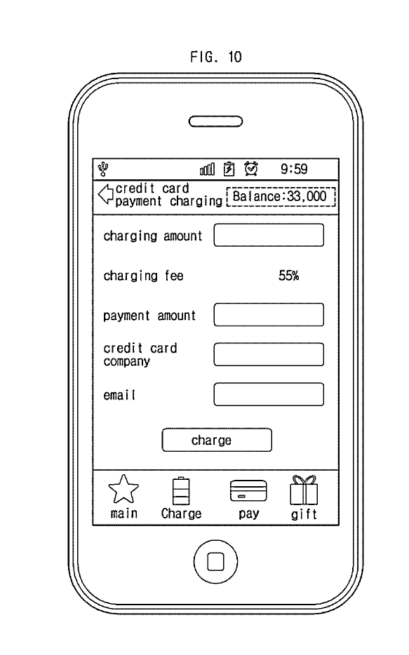

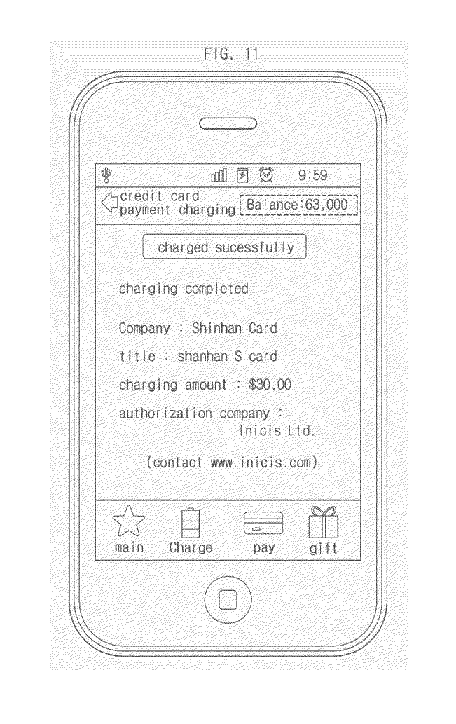

FIG. 8 is a flow chart illustrating a method for depositing ((re)charging) a certain amount to an electronic wallet account corresponding to a user terminal through a small payment in accordance with an embodiment of the present invention. FIG. 9 is a user interface screen displayed through a terminal for depositing ((re)charging) a certain amount to an electronic wallet account corresponding to a small payment in accordance with another embodiment of the present invention. FIG. 10 and FIG. 11 are user interface screens displayed through a user terminal for depositing ((re)charging) a certain amount to an electronic wallet account corresponding to a credit card payment in accordance with another embodiment of the present invention.

As shown in FIG. 9 to FIG. 11, a specially-dedicated program is installed in the user terminal 110 for use of the electronic wallet account or for certain amount deposit ((re)charge) to the electronic wallet account. For the convenience of the description and ease of understanding, it is assumed that the specially-dedicated program is performed and operates with the further charging process as described hereinafter.

As shown in FIG. 9, a user selects a charging menu according to a small payment by the specially-dedicated program performed through the user terminal 110 and then inputs charging amount. The user then inputs terminal information for the terminal to perform a small payment by the specially-dedicated program performed through the user terminal 110. Here, the terminal may be the same as the user terminal 110 or another device.

When the user inputs verification number for a small payment through the user terminal 110 when in the state where the terminal information is input, and requests to charge, a charging process according to FIG. 8 can be performed.

FIG. 10 and FIG. 11 are user interface screens showing charging according to credit card payment. When the user selects a charging menu according to the credit card payment through the user terminal 110, selects charging amount and card information and performs a charging request, the charging process according to FIG. 8 can be performed

In the case of the (re)charging method according to small payment and credit card payment, a payment process according to a method of payment is different but is independent of the charging process. Since each payment process is readily understood and apparent to a person skilled in the art, a detailed explanation is omitted herein.

Referring back to FIG. 8, a charging process, after a payment process according to any one of small payment and credit card payment is completed, is described hereafter.

The user terminal 110 transmits a (re)charging request to the payment support server 120 in Step 810. Here, the (re)charging request may include at least one of (re)charging amount, (re)charging method, and terminal information.

The payment support server 120 checks (re)charging limit of the electronic wallet account linked to the terminal information by using the terminal information included in the (re)charging request in Step 815.

When the recharging request exceeds the (re)charging limit, in Step 820, the payment support server 120 generates and sends a (re)charging impossible message due to exceeding of the (re)charging limit to the user terminal 110. Here, the (re)charging impossible message may include at least one of (re)charging limit and (re)charging limit exceeded amount.

On the other hand, when the recharging request is within the (re)charging limit, the payment support server 120 extracts at least one of virtual account and prepaid card linked to the electronic wallet account and transmits a synchronizing request according to the (re)charging to the user terminal 110 and a predetermined server in Step 825.

For example, when a virtual account is registered by being linked to the electronic wallet account, the payment support server 120 can transmit a synchronizing request to the financial institution system 140 for synchronizing the balance of the virtual account with the balance change of the electronic wallet account. Here, the synchronizing request may include at least one of the changed balance information and the virtual account information. The changed balance information may be balance information according to the use (e.g., use type).

In another example, it is assumed that the electronic wallet account is linked to a prepaid card. Here, it is assumed that the prepaid card is issued by a certain credit card company. The payment support server 120 can transmit a synchronizing request to a predetermined credit card company system in correspondence with the prepaid card. The synchronizing request can include at least one of the changed balance information and the credit card information.

In another example, it is assumed that the prepaid card linked to the electronic wallet account is a transportation card which is issued to a smart card attached to the user terminal. The payment support server 120 can transmit a synchronizing request for synchronizing the balance of the transportation card with the balance change of the electronic wallet account according to (re)charging. Here, the synchronizing request can include changed balance information as described above.

The electronic wallet account can be linked to at least one of a prepaid card and a virtual account. As such, it is also apparent that a synchronizing request for synchronizing the balance of prepaid card and virtual account with the balance change of the electronic wallet account can be transmitted to a predetermined server and the user terminal 110.

The payment support server 120 receives the synchronized result according to the synchronizing request from at least one of the user terminal 110 and the predetermined server in Step 830.

The payment support server 120 adds the (re)charged amount to the balance of the electronic wallet account with receiving the synchronized result in Step 835.

It is apparent to one skilled in the art that Step 835 can be performed prior to Step 825.

The payment support server 120 generates a (re)charging result message reflecting the charged amount and transmits it to the user terminal 110.

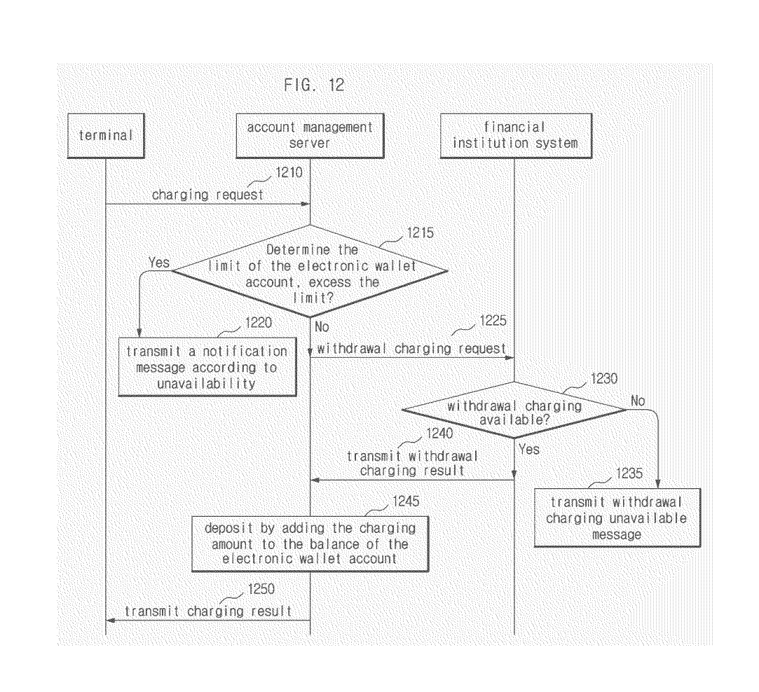

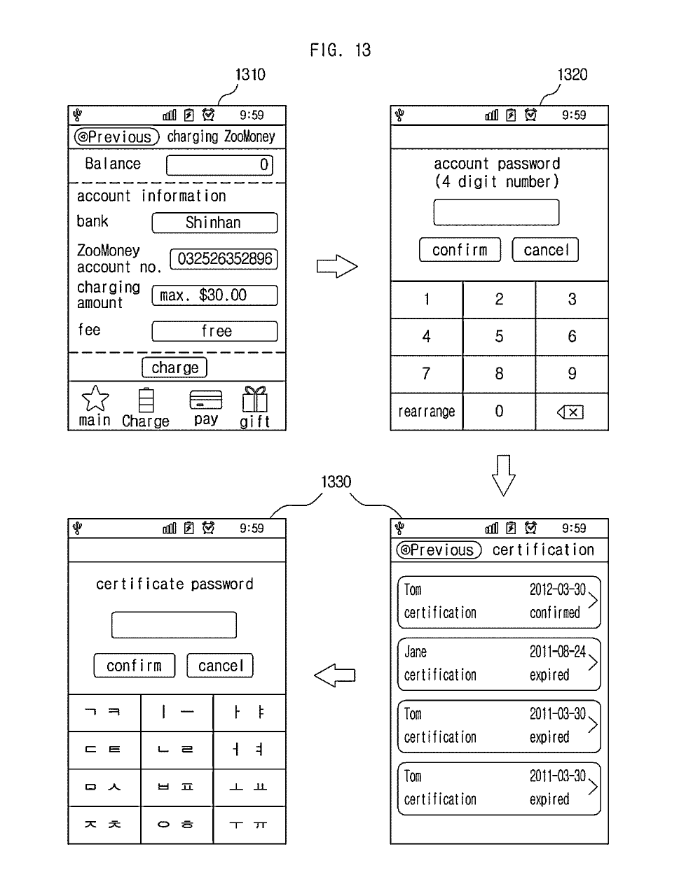

FIG. 12 is a flow chart illustrating a method for charging to the balance of an electronic wallet account through real account transfer in accordance with another embodiment of the present invention. FIG. 13 illustrates a user interface screen displayed through a user terminal for charging to the balance of an electronic wallet account through real (e.g., an actual, real-time transfer-enabled) account transfer in accordance with another embodiment of the present invention.

As shown in FIG. 13, a user selects (or inputs) real account information by a performed specially-dedicated program and (re)charging amount to the user terminal 110. The user inputs a real account password to the user terminal 110 and selects an electrical (e.g., digital) certificate required for transferring (re)charging amount from a real account. It is assumed here that the electrical certificate is installed in the user terminal 110. The user then inputs password in the electrical certificate (referred to as certificate password) to the user terminal 110.

Here, when the user selects a (re)charging menu through the user terminal 110, the user terminal 110 transmits a (re)charging request to the payment support server 120 in Step 1210. The (re)charging request can include at least one of real account information (real account number and real account password), electrical certificate information (selected certificate and certificate password) and (re)charging amount.

The payment support server 120 determines the limit amount and balance of electronic wallet account corresponding to the user terminal 110 in accordance with the (re)charging request and further determines if (re)charging amount is within the limit in Step 1215.

When the (re)charging amount exceeds the limit, the payment support server 120 generates an information message for exceeding of the limit and transmits it to the information message in Step 1220. Here, the information message according to the exceeding of the limit can include (re)charging available amount.

Alternatively, when the (re)charging amount is within the limit, the payment support server 120 transmits a withdrawal (re)charging request including real account information and (re)charging amount to the financial institution system 140 in Step 1325.

The financial institution system 140 determines availability of the real account information according to the withdrawal (re)charging request and if the balance is sufficient for the (re)charging amount to determine availability of withdrawal (re)charging in Step 1230.

When withdrawal charging is not available, the financial institution system 140 generates an information message including a “withdrawal (re)charging unavailable” reason (referred to as withdrawal (re)charging unavailable message) and transmits it to the payment support server 120 in Step 1235.

Alternatively, when withdrawal charging is available, the financial institution system 140 deducts the (re)charging amount from the real account, and generates and transmits a withdrawal (re)charging result to the payment support server 120 in Step 1240.

Here, when the financial institution system is a financial institution system managing a virtual account linked to the electronic wallet account, the financial institution system 140 can deduct the (re)charging amount from the real account and transfer the funds to the virtual account.

The payment support server 120 adds (e.g., deposits) the (re)charging amount to the balance of the electronic wallet account with receiving the withdrawal (re)charging result from the financial institution system 140 in Step 1245. The payment support server 120 then performs synchronizing process with virtual account or prepaid card linked to the electronic wallet account.

The payment support server 120 generates (re)charging result to reflect the (re)charging and transmits it to the user terminal 110 in Step 1250.

The method for depositing a certain amount to the electronic wallet account by various methods has been described in accordance with FIG. 7 to FIG. 12. In addition to the method described in FIG. 7 to FIG. 12, when a user purchases a product with cash at a POS, the change can be deposited to the electronic wallet account instead of the user receiving the monetary change with cash. That is, a change (re)charging request including the change amount and terminal information of the user terminal can be transmitted from the POS terminal to the payment support server 120. The payment support server 120 can deposit the change to the balance of the electronic wallet account corresponding to the terminal information and transmit the result to at least one of the user terminal and the POS terminal. The change (re)charging result can include at least one of the changes and the total balance of the electronic wallet account. As such, this reduces inconvenience of receiving and carrying the change but also contributes to the distribution of change over various transactions by depositing the change to the balance of the electronic wallet account through an alliance with participating POSs.

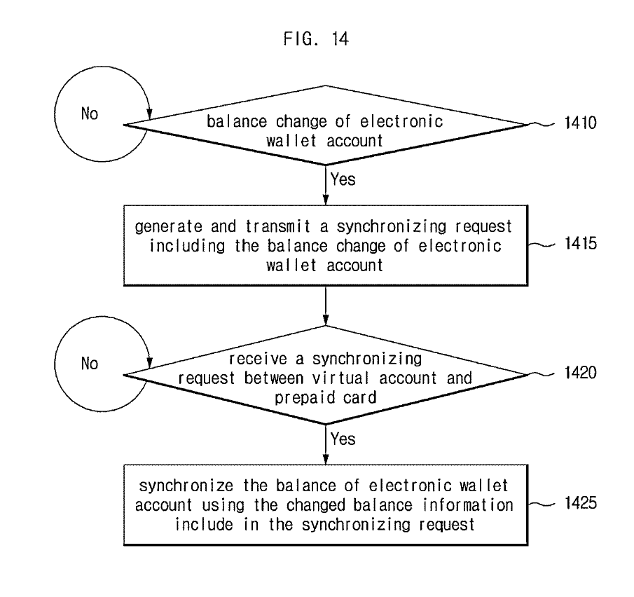

FIG. 14 is a flow chart illustrating a method for synchronizing the balance of a virtual account or a prepaid card according to the balance changes of an electronic wallet account at a payment support server in accordance with an embodiment of the present invention. Here, the prepaid card may include a transportation card.

The payment support server 120 determines whether a balance of the electronic wallet account associated with a user is changed in Step 1410. Here, the change may be increment or decrement of the balance.

When the balance is not changed (No—Step 1410), it may wait at Step 1410.

Alternatively, when the balance is changed (Yes—Step 1410), the payment support server 120 generates a synchronizing request including the balance change information of the electronic wallet account and transmits it to the user terminal 110 or the predetermined server in Step 1415.

Here, the synchronizing request may further include virtual account or prepaid card information.

Accordingly, when the balance change occurs in the electronic wallet account, the payment support server 120 can synchronize with the linked virtual account or the balance of the prepaid card.

The payment support server 120 then determines whether the synchronizing request is received from the user terminal 110 or the predetermined server in Step 1420.

Here, the synchronizing request may include the virtual account or prepaid card information or the balance change information. The synchronizing request can also include electronic wallet account linked to the virtual account or the prepaid card.

For example, when the balance of the virtual account of the financial institution system 140 is changed, the financial institution system 140 can transmit the synchronizing request including the change information and the virtual account information to the payment support server 120. This can be applied equally to a prepaid card of a credit card system. That is, when the prepaid card issued by the credit card company is used for purchasing a product, a credit card company system deducts the payment amount from the balance of the prepaid card according to the payment using the prepaid card and requests for synchronizing by transmitting the changed balance information and the prepaid card information to the payment support server 120.

In another example, when traffic charge is paid using a transportation card issued on the user terminal 110 of a user, the user terminal 110 can transmit the balance change associated with use of the transportation card through a hidden program executing in background to the payment support server 120. The user terminal 110 can store an amount available for transportation card payment from the electronic wallet account by linking to the payment support server 120. Accordingly, when the balance is deducted through close contact to a reader attached to a public transportation to pay the traffic charge, the user terminal 110 can notify the deducted amount and the deducted balance to the payment support server 120 through the hidden program executing in background. Accordingly, the payment support server 120 can deduct the deducted amount from the balance of the electronic wallet account or synchronize the balance of the electronic wallet account with the deducted balance. Here, when the use is designated for the balance of the electronic wallet account, it can deduct the deducted amount from the balance for the use or synchronize the total balance according to the deducted balance with the deducted balance.

The payment support server 120 can receive the balance change of the virtual account or the prepaid card, which is linked to the electronic wallet account, from the predetermined server or the user terminal 110 and synchronize it with the balance of the electronic wallet account.

When the synchronizing request is not received from the user terminal or the predetermined server, the payment support server 120 synchronizes the balance of the electronic wallet account using the changed balance information included in the synchronizing request in Step 1420.

On the other hand, when the synchronizing request is received from the user terminal or the predetermined server (Yes-Step 1420), the payment support server 120 synchronizes the balance of the electronic wallet account using the changed balance information included in the synchronizing request in Step 1425.

Here, the changed balance information may be total balance information according to the balance increase or the balance decrease, or the increased balance or the decreased balance.

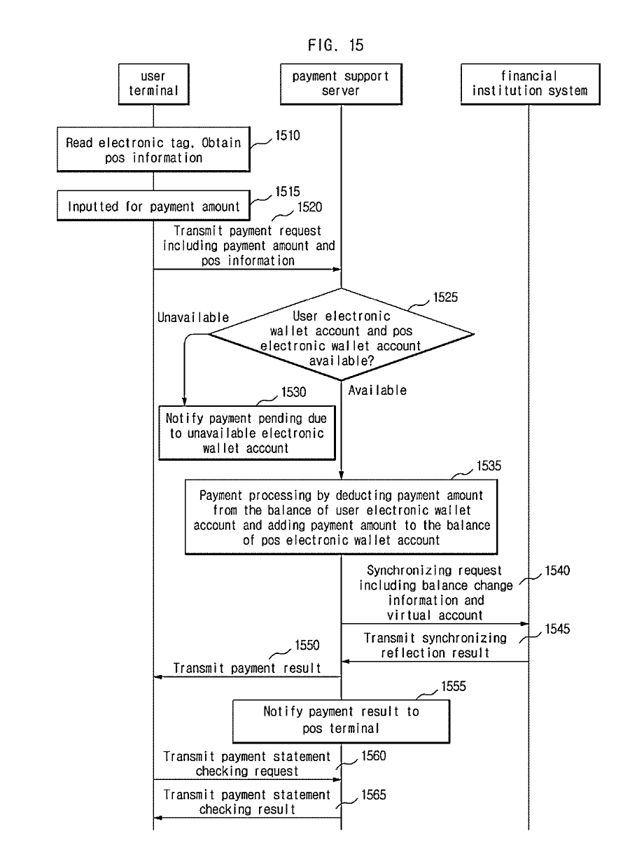

FIG. 15 is a flow chart illustrating a payment method using an electronic wallet account in accordance with an embodiment of the present invention.

A user obtains POS information by reading an electronic tag attached to a POS and displayed through a POS terminal 130 in order to purchase a certain product and pay therefor at the POS in Step 1510. Here, the electronic tag may be an RFID tag, an NFC tag, or an N-dimensional code such as a QR code or a barcode.

Even if a method for obtaining information through a tag varies with a type of tags, the method for obtaining information through the above-mentioned tag is apparent to a person skilled in the art. Thus, detailed explanation thereof herein is omitted.

A payment amount is input to the user terminal 110 in Step 1515.

The user terminal 110 transmits a payment request including the payment amount and POS information to the payment support server 120 in Step 1520. Here, the payment request can further include terminal information such as telephone number of the user terminal 110.

Moreover, when a password is set up for using an electronic wallet account, the password can be input by a user to the user terminal 110 which can then transmit a payment request with the password.

The payment support server 120 identifies the electronic wallet account corresponding to the user terminal 110 (referred to as user electronic wallet account) and the electronic wallet account corresponding to the POS information (referred to as POS electronic wallet account) according to the receiving the payment request from the user terminal 110, respectively and further determines if the accounts are in available conditions in Step 1525.

For example, the payment support server 120 determines the status and the balance of the user electronic wallet account and further determines if it is possible to process the payment amount according to the payment request.

The payment support server 120 also determines the status of the POS electronic wallet account and further determines if it is possible to reflect the deposit.

Here, when any one of the user electronic wallet account and the POS electronic wallet account is not available (Unavailable—Step 1525), the payment support server 120 does not authorize the payment and can notify at least one of the user terminal 110 and the POS terminal 130 corresponding to the POS information in Step 1530.

Alternatively, when the user electronic wallet account and the POS electronic wallet account are available (Available—Step 1525), the payment support server 120 deducts the payment amount from the balance of the electronic wallet account and adds the payment amount to the balance of the POS electronic wallet account in Step 1535.

The payment support server 120 then transmits a synchronizing request including the balance change information and the virtual account to the financial institution system 140 for synchronizing with the virtual account according to the payment processing in Step 1540.

Here, the synchronizing request may include respective balance change information and respective virtual account information of the user electronic wallet account and the POS electronic wallet account.

Accordingly, the balance of the virtual account linked to the balance change of the user electronic wallet account and that linked to the balance change of the POS electronic wallet account can be synchronized, respectively.

The payment support server 120 receives the synchronized result from the financial institution system 140 in Step 1545.

The payment support server 120 transmits the payment result according to the payment request to the user terminal 110 in Step 1550. Here, the payment result may include at least one of payment processed electronic wallet account information, payment amount and user information (for example, telephone number).

Moreover, the payment support server 120 can notify the payment result according to the payment processing to the POS terminal 130 in Step 1555.

Here, the payment support server 120 can notify the payment result in a text form such as short message, long message, and multimedia message to the POS terminal 130.

Further, the payment support server 120 can notify the payment result in a push mail form to the POS terminal 130.

In another example, a type of the POS terminal 130 according to the POS information is 3G terminal. In this case, the payment support server 120 can notify the payment result in a callback text message to the POS terminal 130. Accordingly, the POS terminal 130 can verify the payment result through the callback text message.

Moreover, the payment support server 120 can store the payment statement according to the payment processing in correspondence with at least one of the terminal information (for example, telephone number) of the user terminal and the POS information.

The payment support server 120 receives a payment statement checking request from the user terminal 110 in Step 1560.

Accordingly, the payment support server 120 extracts the payment statement corresponding the terminal information (for example, telephone number) according to the receiving the payment statement checking request of the user terminal 110 and transmits payment statement checking result including it to the user terminal 110 in Step 1565.

Here, the payment support server 120 can arrange the payment statement ordered by date and provides it to the user terminal 110. Further, the payment support server 120 can also arrange the payment statement ordered by paid POS information and provide this to the user terminal 110.

For example, a payment is made at a first POS today and another payment was made at a second POS yesterday.

In this case, the payment support server 120 arranges the paid payment statement corresponding to the first POS by date for a recent certain period of time as a first arrangement and arranges the paid payment statement corresponding to the second POS by date for a recent certain period of time as a second arrangement and then provides the result to the user terminal 110.

When the payment statement of POS information to be checked can be input or selected separately from the user terminal 110, the payment statement only corresponding to that POS information can be provided by being arranged in a predetermined arrangement method.

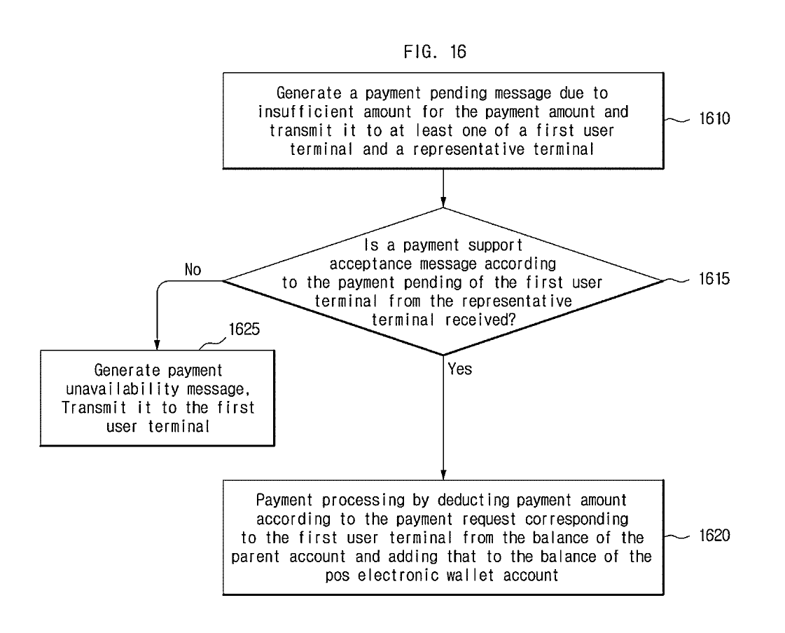

FIG. 16 is a flow chart illustrating a payment method at an electronic wallet account included in a group in accordance with an embodiment of the present invention. An account managing the total balance of group members is referred to as a parent account and a terminal corresponding to the parent account is referred to as a representative terminal for the convenience of the description and understanding of the embodiments.

For the example, a first electronic wallet account and a second electronic wallet account are set for each group member at the parent account, although the present invention is not limited thereto and varying numbers of wallet accounts might be provisioned. In the case where a payment amount is processed from the first electronic wallet account, the following describes in detail when the payment amount is insufficient.

If the payment support server 120 notifies a recipient via a payment pending message due to insufficient amount (funds) for the payment amount to the user terminal 110, and the further process is described hereinafter according to Step 1610 to Step 1620 in FIG. 15.

The payment support server 120 generates a payment pending message due to insufficient amount for the payment amount and transmits it to at least one of a first user terminal and a representative terminal in Step 1610.

Here, the payment pending message can include at least one of terminal information of the terminal processing the payment (or electronic wallet account) and insufficient payment amount.

Here, it can include the payment amount, instead of the insufficient payment amount.

Moreover, the first user terminal can generate a payment support verification request message according to the payment pending message and transmit it to the representative terminal.

The payment support server 120 determines if a payment support acceptance message is received according to the payment pending of the first user terminal from the representative terminal in Step 1615.

When the payment support acceptance message is not received, it waits at Step 1615. Here, when the payment support acceptance message is not received within a certain period of time, the payment support server 120 generates a payment unavailability message according to a payment request of the first user terminal and transmits it to the first user terminal at Step 1625.

When the payment support acceptance message is received, the payment support server 120 deducts payment amount according to the payment request corresponding to the first user terminal from the balance of the parent account and adds that to the balance of the POS electronic wallet account in Step 1620.

In another example, the payment support server 120 deducts a part of payment amount corresponding to the balance of the user electronic wallet account of the first user terminal among the total payment amount from the user electronic wallet account, deducts the rest insufficient payment amount from the balance of the parent account, and adds the total payment amount to the balance of the POS electronic wallet account for the payment processing.

Since a method for notifying the payment result to the POS terminal and that for checking the payment statement is substantially similar to that as described above in FIG. 15, the details are omitted herein.

When payment is processed for a part of the payment amount or the payment amount from the parent account, a synchronizing process with the balance of the virtual account or the prepaid card linked to the balance change of the parent account can be conducted. Since this is substantially similar to that as described above with reference to FIG. 14, a detailed description is omitted herein.

As shown in FIG. 16, the embodiment is described such that the payment amount is deducted at the representative terminal representing the group from the balance of the parent account corresponding to the representative terminal according to payment support acceptance for the insufficient payment amount of the electronic wallet account of the first user terminal.

However, the representative terminal can process the payment by transferring the insufficient payment amount from the parent account to the electronic wallet account corresponding to the first user terminal.

Even though it is not separately described that each electronic wallet account is designated for the use in FIG. 16, each balance of electronic wallet account can be designated for the use (e.g., designated for each use type). In this case, the representative terminal can deduct the insufficient payment amount (or total payment amount) from the balance for the use allowed for the payment support of the first user terminal or transfer it to the electronic wallet account for the payment processing.

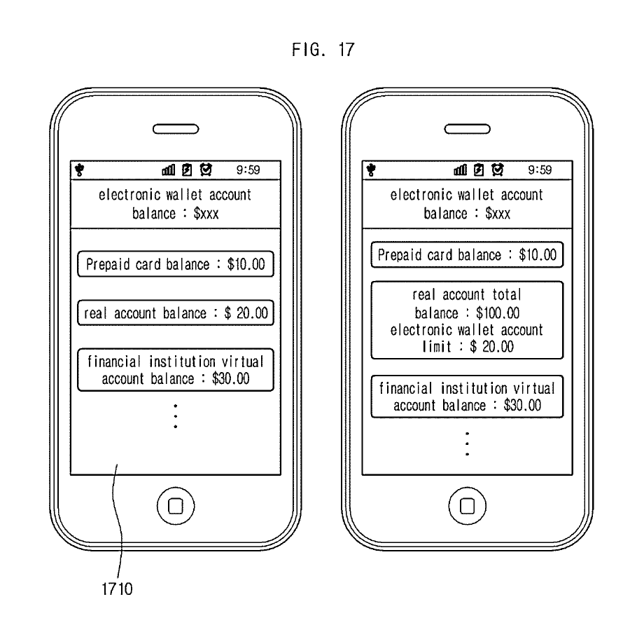

FIG. 17 is a screen illustrating a method for making a payment according to the priorities set for various accounts in accordance with an embodiment of the present invention when a plurality of other accounts are registered with being linked to the electronic wallet account.

The electronic wallet account of a user can be registered to be linked to each of other accounts (for example, prepaid card, financial institution real account, financial institution virtual account, debit card, mobile phone small payment) for the convenience of the description and understanding of the embodiments.

The user terminal 110 can process a certain app. (or web browser) for the payment service according to the electronic wallet account or after being verified from each account server for each balance of other accounts linked to the electronic wallet account through the payment support server 120 at the time when the electronic wallet account is actually used, and display the result. Here, in case of a debit card or a mobile phone small payment, after being verified for the available limit (available balance) by being linked to a credit card company or mobile phone small payment system, the payment support server 120 can display the result on the user terminal 110.

A screen 1710 illustrates the balance or available limit amount of other accounts linked to the electronic wallet account on the user terminal 110. Even though the screen 1710 illustrates each balance or available limit amount of other accounts linked to the electronic wallet account, the total amount can be displayed in an added form.

It is assumed that the other accounts linked to the electronic wallet account are registered in a prioritized order, for example, in an order of a prepaid card, a financial institution real account, a financial institution virtual account, a debit card and a mobile phone small payment.

A payment available limit and the use of each of the other accounts linked to the electronic wallet account can be designated separately by being linked to the corresponding electronic wallet account. For example, while it is assumed that the balance of a financial institution real account is $100.00, a user can set the available limit for $10.00 at the financial institution real account by being linked to the electronic wallet account. Here, the available limit can be a daily limit or one-time limit or a limit for a one-month period of time.

As such, when a priority use for the other accounts linked to the electronic wallet account is designated, it is assumed that a user is provided $100.00 through the electronic wallet account. It is also assumed that the balance of the electronic wallet account is $50.00, that of the prepaid card is $20.00, that of the financial institution real account is $20.00 and that of the financial institution virtual account is $30.00.

The payment support server 120 can process to deduct $50.00 from the electronic wallet account, $10.00 from the prepaid card, $20.00 from the financial institution real account and $20.00 from the financial institution virtual account according to the designated prioritized order for $100.00 payment request from the electronic wallet account of the user terminal 110.

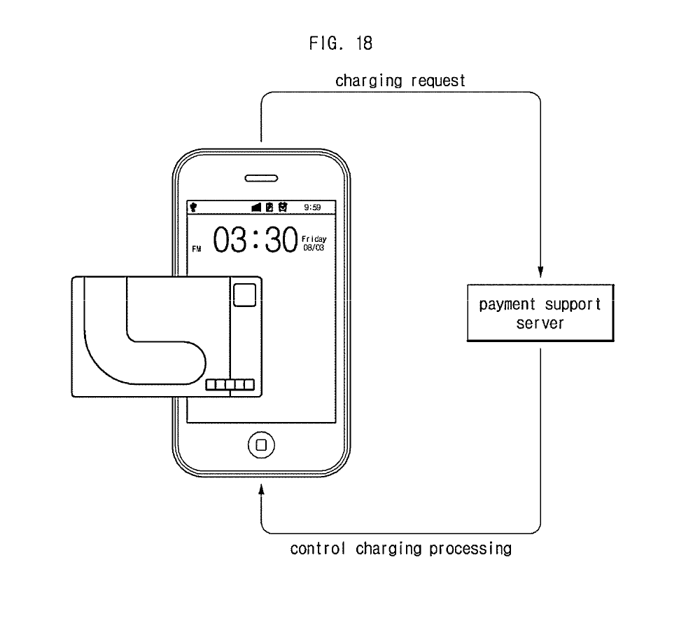

FIG. 18 is a screen illustrating a method for charging a prepaid transportation card through an electronic wallet account in accordance with an embodiment of the present invention. The prepaid transportation card can be realized in a program form though the user terminal 110 or in a plastic card form such as generally mounted IC chips.

The user terminal 110 is selected for a prepaid transportation card (re)charging menu through an electronic wallet specially-dedicated program by a user. The user terminal 110 is input for (re)charging amount to be charged to the prepaid transportation card by a user. The user terminal 110 transmits a (re)charging request for charging the prepaid transportation card to the payment support server 120. Here, the (re)charging request can include (re)charging amount and (re)charging type. The (re)charging type can be prepaid transportation card charging through the electronic wallet account.

The payment support server 120 receives a (re)charging request from the user terminal 110 and identifies if the (re)charging request is prepaid transportation card charging through the electronic wallet account according to the (re)charging type include in the (re)charging request. Accordingly, the payment support server 120 checks if the balance of the electronic wallet account is sufficient for the (re)charging amount. If the balance is more than the (re)charging amount, the amount corresponding to the (re)charging amount among the balances of the electronic wallet account can be set for the prepaid transportation card use.

The payment support server 120 can deduct (re)charging amount from the balance of the electronic wallet account, deposit it temporally to the virtual account of the payment support server 120, and then process a charging for the (re)charging amount to the prepaid transportation card through the user terminal 110.

The user terminal 110 converts near field communication module of the user terminal 110 to card emulation mode according to a (re)charging processing request to record (re)charging amount to the prepaid transportation card in which IC chips are installed. The user terminal 110 processes a charging by adding the (re)charging amount to the balance of the prepaid transportation card through the near field communication module by close contact of the prepaid transportation card.

Here, the user terminal 110 converts near field communication module of the user terminal 110 to reader mode to read the balance of the prepaid transportation card by close contact of the prepaid transportation card according to the (re)charging processing request of the payment support server 120 and reads first the balance. As such, when the balance information is obtained, the user terminal 110 can convert mode of the near field communication module to card emulation mode and then record the sum of the balance and the (re)charging amount on the prepaid transportation card.

In another example, when the prepaid transportation card is presented via a program form on the user terminal 110, the user terminal 110 can designate the use for the amount corresponding to the (re)charging amount among the balance of the electronic wallet account of a user for a transportation card by being linked to the payment support server 120. The user terminal 110 can first store the amount corresponding to the (re)charging amount at the user terminal 110 and the amount can be then deducted with use through a transportation card program.

A method for providing a payment service between terminals using an electronic wallet account linked with a telephone number in accordance with an embodiment of the present invention can be realized in a program instruction form which can be performed by employing various means for processing information electronically to be recorded on a storage medium. The storage medium can include program instruction, data file data structure and the like alone or in a combination.

The program instruction to be recoded on the storage media can be particularly designed and structured or any one well-known to a person skilled in the software field. Example of the storage media includes magnetic media such as hard disk, floppy disk and magnetic tape, optical media such as CD-ROM, DVD, magneto-optical media such as optical disk, and a hardware device which is specially designed to store and process program instruction such as ROM, RAM, flash memory and the like. Example of the program instruction includes a machine language code made by compiler, a device processing electronically information using an interpreter, for example, a high level language code which can be implemented by computer.

The above-mentioned hardware device can be configured to be operated with one or more software modules and Vice versa

While it has been described with reference to particular embodiments, it is to be appreciated that various changes and modifications can be made by those skilled in the art without departing from the spirit and scope of the embodiment herein, as defined by the appended claims and their equivalents.

What is claimed is:

1. A payment method comprising:
receiving a payment request including user information, point of sale (POS) information, and payment amount from a user terminal, wherein the user terminal obtains the POS information by reading a tag displayed through a POS terminal or attached to the POS;
processing a payment by deducting the payment amount from the balance of a first electronic wallet account linked to the user information according to the payment request and adding the payment amount to the balance of a second electronic wallet account linked to the POS information; and
notifying the payment processing result to at least one of the user terminal and the POS terminal corresponding to the POS information.

2. The payment method of claim 1, wherein at least one of the user information and the POS information is a telephone number.

3. The payment method of claim 1, after the payment processing, further comprising
synchronizing at least one balance of a prepaid card and a virtual account linked with the first electronic wallet account according to the change in the balance of the first electronic wallet account.

4. The payment method of claim 3, wherein the synchronizing the balance comprises:
transmitting a synchronizing request including the balance information changed according to the payment processing to the user terminal and a server authorizing use of a prepaid card, if the first electronic wallet account is linked with the prepaid card; and
transmitting, to a financial institution system, a synchronizing request including the balance information changed according to the payment processing, if the first electronic wallet account is linked with a virtual account.

5. The payment method of claim 1, after the payment processing, further comprising
synchronizing with the balance of the virtual account by transmitting a synchronizing request including the balance information changed according to the payment processing to a financial institution system, if the second electronic wallet account is linked to a virtual account.

6. The payment method of claim 1, wherein the processing a payment deducts the payment amount from the balance authorized for the use from the total balance of the first electronic wallet account.

7. The payment method of claim 1, after the payment processing, further comprising
reflecting the change by deducting the balance changed according to the payment processing from the total balance of a patent account in the group, if the first electronic wallet account is configured as a group.

8. The payment method of claim 1, wherein, prior to the processing a payment, the method comprising:
according to the payment request, when the balance of the first electronic wallet account is less than the payment amount, transmitting a payment pending message due to insufficient balance to at least one of the user terminal and a representative terminal corresponding to the parent account of the group including the first electronic wallet account;
receiving a payment verifying request from the parent account to the first electronic wallet account for the insufficient payment amount among the payment amount from the representative terminal; and
processing by deducting the insufficient payment amount from the balance of the parent account and adding that to the balance of the first electronic wallet account.

9. The payment method of claim 1, wherein prior to the processing a payment, the payment method comprising:
according to the payment request, when the balance of the first electronic wallet account is less than the payment amount, transmitting a payment pending message for the insufficient payment amount to at least one of the user terminal and a representative terminal corresponding to the parent account of the group including the first electronic wallet account; and
receiving a payment verifying request from the parent account to the first electronic wallet account for the insufficient payment amount among the payment amount from the representative terminal,
wherein in the processing a payment, a part of the payment amount is deducted from the balance of the first electronic wallet account, a remainder of the payment amount is deducted from the balance of the parent account, and the payment amount is added to the balance of the second electronic wallet account.

10. The payment method of claim 1, further comprising:
receiving a synchronizing request including balance information according to a prepaid card payment; and
synchronizing the balance of the first electronic wallet account with the balance information according to the synchronizing request.

11. The payment method of claim 10, wherein:
the prepaid card is a transportation card issued to a smart card attached to the user terminal; and
the user terminal transmits a synchronizing request including the balance information when the balance is changed with payments of the transportation card through a background-executing program.

12. The payment method of claim 1, wherein the first electronic wallet account is linked with a plurality of other accounts prioritized in accordance with their uses.

13. The payment method of claim 12, wherein deducting the payment amount from the balance of the first electronic wallet account is processed by deducting the payment amount from the balance of the other accounts in the prioritized order.

14. A payment support server comprising:
a communication unit configured to receive a payment request including user information, POS information and payment amount from a user terminal, wherein the user terminal obtains the POS information by reading a tag attached to a POS and displayed through a POS terminal;
a service control unit configured to process a payment by deducting the payment amount from the balance of the first electronic wallet account in accordance with the payment request and adding the payment amount to the balance of the second electronic wallet account linked to the POS information; and
a message generating unit configured to generate a payment result message corresponding to the payment processing,
wherein the payment result message is transmitted to at least one of the user terminal and the POS terminal corresponding to the POS information.

15. The payment support server of claim 14, wherein at least one of the user information and POS information is a telephone number.

16. The payment support server of claim 14, further comprising a synchronizing unit configured to synchronize at least one balance of a prepaid card and a virtual account linked to the first electronic wallet account according to the balance change of the first electronic wallet account.

17. The payment support server of claim 16, wherein:
if the first electronic wallet account is linked to a prepaid card, the synchronizing unit transmits a synchronizing request including the changed balance information, changed according to the payment processing by the service control unit, to the user terminal and a server verifying the use of the prepaid card; and
if the first electronic wallet account is linked to a virtual account, the synchronizing unit transmits synchronizing request to a financial institution system.

18. The payment support server of claim 16, wherein the synchronizing unit, if the second electronic wallet account is linked to a virtual account, transmits a synchronizing request including the changed balance information, changed according to the payment processing by the service control unit, to a financial institution system and synchronizes it with the balance of the virtual account.

19. The payment support server of claim 16, wherein the synchronizing unit, if the first electronic wallet account is configured as a group, reflects the changed balance, changed according to the payment processing by the service control unit, to the balance of a parent account of the group.

20. The payment support server of claim 19, wherein:
the balance of each electronic wallet account is specified and managed according to corresponding use types; and
the parent account is configured to manage a total balance for the use types by combining the balance of the electronic wallet account of each member of the group according to the corresponding use type.

21. The payment support server of claim 20, wherein the service control unit deducts the payment amount from the balance authorized for the use type of the total balance of the first electronic wallet account and the synchronizing unit synchronizes by deducting the balance deducted for the payment processing according to the use type.

22. The payment support server of claim 14, further comprising
an account verification unit configured to determine if the balance of the first electronic wallet account is less than the payment amount or not according to the payment request,
wherein, when the balance of the first electronic wallet account is less than the payment amount, the service control unit is configured to transmit a payment pending message caused due to insufficient balance to at least one of the user terminal and a representative terminal corresponding to the parent account of the group including the first electronic wallet account, and
wherein, when a payment verifying request is received to process a payment for the insufficient payment amount through the parent account from the representative terminal, the service control unit is configured to conduct the payment processing according to the payment request by deducting the insufficient payment amount from the balance of the parent account and adding it to the balance of the first electronic wallet account.

23. The payment support server of claim 14, further comprising
an account verification unit configured to determine if the balance of the first electronic wallet account is less than the payment amount or not according to the payment request,
wherein, when the balance of the first electronic wallet account is less than the payment amount, the service control unit is configured to transmit a payment pending message caused due to insufficient balance to at least one of the user terminal and a representative terminal corresponding to the parent account of the group including the first electronic wallet account, and
wherein, when a payment verifying request is received to process a payment for the insufficient payment amount through the parent account from the representative terminal, the service control unit is configured to conduct the payment processing by deducting a part of the payment amount from the balance of the first electronic wallet account and deducting the rest of the payment amount from the balance of the parent account.

24. The payment support server of claim 16, wherein the synchronizing unit, when a synchronizing request including balance information according to a prepaid payment is received, is configured to synchronize the balance information with the balance of the first electronic wallet account.

25. The payment support server of claim 24, wherein when the prepaid card is a transportation card issued to a smart card attached to the user terminal, the user terminal transmits a synchronizing request including the balance information when the balance is changed with payments of the transportation card through a background-executing program.

26. The payment support server of claim 14, wherein the first electronic wallet account is linked with another account.

27. The payment support server of claim 26, wherein the other account is at least one of a credit card, a prepaid card, financial institution real account, financial institution virtual account, mobile phone small payment.

28. The payment support server of claim 26, wherein the other account is prioritized according to a corresponding use type, and the service control unit deducts the payment amount from the balance of the other accounts according to a prioritized order.

29. A payment system comprising:
a user terminal configured to obtain POS information by reading a tag attached to a POS or displayed through a POS terminal, and to generate a payment request including the obtained POS information and a payment amount; and
a payment support server configured to process a payment by deducting the payment amount from the balance of the first electronic wallet account linked to the user terminal and corresponding to the payment request of the user terminal and adding the payment amount to the balance of the second electronic wallet account linked to the POS information.

30. The payment system of claim 29, wherein the payment support server is configured to generate a payment result message according to the payment processing and transmit the result to at least one of the user terminal and the POS terminal.

31. The payment system of claim 29, wherein the tag is at least one of a near field communication (NFC) tag, a radio frequency identification (RFID) tag, a barcode, and a quick response (QR) code.

32. The payment system of claim 29, wherein the payment support server is configured to:
manage at least one of a prepaid card and a virtual account corresponding to the electronic wallet account; and
transmit a synchronizing request for synchronizing with the balance of the prepaid card and the virtual account to at least one of the user terminal and a predetermined server when the balance of the electronic wallet account changes.

33. The payment system of claim 32, wherein the prepaid card is a transportation card issued to a smart card of the user terminal or stored in a server.
